(19) United States
(12) Patent Application Publication
(10) Pub. No.: US 2024/0159163 A1
(43) Pub. Date: May 16, 2024

(54) METHOD FOR MANUFACTURING A TURBOMACHINE COMPONENT MADE OF COMPOSITE MATERIAL WITH A STIFFENING ZONE

(71) Applicant: SAFRAN, Paris (FR)

(72) Inventors: François CHARLEUX, MOISSY-CRAMAYEL (FR); Marc-Antoine COLOT, MOISSY-CRAMAYEL (FR)

(73) Assignee: SAFRAN, Paris (FR)

(21) Appl. No.: 18/550,063

(22) PCT Filed: Mar. 16, 2022
(86) PCT No.: PCT/FR2022/050470

§ 371 Date: Sep. 11, 2023

(30) Foreign Application Priority Data
Mar. 17, 2021 (FR) FR2102685

(51) Int. Cl. F01D 25/00; B29C 70/24; B29K 105/08; B29L 31/00; B32B 5/02; B32B 5/12; B32B 5/26; D03D 25/00

(52) U.S. Cl. CPC F01D 25/005; B29C 70/24; B32B 5/024; B32B 5/12; B32B 5/263; D03D 25/005; B29K 2105/0845; B29L 2031/7504; F05D 2300/6012; F05D 2300/6034; F05D 2300/614

(57) ABSTRACT

A method for manufacturing a turbomachine component made of composite material includes the step of creating a shaped fibrous preform by three-dimensional weaving of filaments to create a fibrous texture which is wound in several superposed layers onto a mandrel of a profile corresponding to that of the component that is to be manufactured, so as to obtain the fibrous preform of a shape corresponding to that of the component that is to be manufactured, the filaments being divided into warp filaments and weft filaments, the warp filaments being interwoven with the weft filaments in a three-dimensional weave. The method further includes the step of creating a stiffening zone in the fibrous preform, the stiffening zone being formed of at least one layer of warp filaments not interwoven with weft filaments that is interposed between the interwoven warp filaments and weft filaments.

### TECHNICAL FIELD

The invention concerns the integration of a stiffening zone into a turbomachine component made of composite material by three-dimensional (3D) filaments weaving, such as a casing, an intermediate casing shell (ICS) or an outlet guide vane (OGV).

### PRIOR ART

The technical background comprises the documents FR 3 085 299 A1, US 2019/160765 A1 and DE 100 25 628 A1.

Turbomachine components such as fan casing, an ICS and an OGV can be made of composite materials.

More specifically, the composite components are produced by shape weaving, and consist of a three-dimensionally (3D) woven preform with, for example, four layers of warp filaments (the warp filaments being arranged lengthways) and four layers of weft filaments (the weft filaments being arranged widthways), the warp filaments being linked by the weft filaments in a three-dimensional weaving.

To reinforce these turbomachine components, allowances can be added to the 3D woven preform. For example, the titles of the warp filaments can be increased.

If this allowance is not sufficient, the number of layers of warp filaments, and therefore the number of layers of weft filaments, can be increased, for example to eight layers of warp filaments and of weft filaments. However, this has the consequence that the thickness of the component is increased, since these layers of weft filaments are present along the entire length of the component, and not just locally where the allowance is desired. This also increases the mass of the component. Moreover, this has an impact on the whole component, not just the zone of the component where a reinforcement is required.

Increasing the stiffness of a component, for example a casing, can be achieved by adding a stiffener, i.e. a reinforcement that locally increases the thickness of the component. A stiffener is an additional component, for example made of composite material, which is fitted to the turbomachine component and assembled to it, for example by gluing. Thanks to such a stiffener, the component remains iso-thick outside the reinforced zone.

As shown in FIG. 1A, a stiffener can be produced by gluing a reinforcement 10, here in the form of an omega, to the turbomachine component 12. However, such a stiffener is produced separately, in particular by draping and polymerisation, and is then glued to the component 12 after machining. The gluing operation may also require the use of an autoclave, which is an expensive item of equipment.

A stiffener can also be produced by weaving a local allowance onto the component. However, this allowance has an impact on the adjacent zones of the component, particularly when the component is made by shape weaving. To increase the thickness of the component, it is necessary to add one or more layers of warp filaments, and therefore one or more layers of weft filaments. This has an impact on the zones of the component other than where the stiffener is located.

The purpose of the invention is to propose a solution allowing to remedy at least some of these disadvantages.

### SUMMARY OF THE INVENTION

The invention thus proposes a method for manufacturing a turbomachine component with a local stiffening allowance, obtained by shape weaving, without impact on the zones adjacent to this stiffening zone, and maximising the circumferential Young's modulus of the turbomachine component.

To this end, the invention relates to a method for manufacturing a turbomachine component made of composite material, said method comprising the steps consisting in:
producing a fibrous preform by three-dimensional weaving of filaments so as to produce a fibrous texture, which is wound in a plurality of superposed layers on a mandrel with a profile corresponding to that of the component to be manufactured, in order to obtain the fibrous preform with a shape corresponding to that of the component to be manufactured, the filaments being separated into warp filaments and weft filaments, the warp filaments being interwoven with the weft filaments in a three-dimensional weaving, and
creating a stiffening zone in the fibrous preform.

According to the invention, said stiffening zone is formed by at least one layer of warp filaments not interwoven with weft filaments interposed between the warp filaments and the weft filaments that are interwoven.

According to the invention, the warp filaments which are not interwoven with the weft filaments making up the stiffening zone are inserted in the core, i.e. substantially in the middle of the thickness of the preform. These additional warp filaments are woven in a weave that gives them minimum shortening, while the other warp and weft filaments maintain paths leading to a shortening equivalent to that which they would have if these additional warp filaments were not added. The shortening is the ratio of the curvilinear length within a fabric to the length of that fabric. This allows to maximise the circumferential Young's modulus. The warp and the weft filaments that are interwoven form a binding within which the additional warp filaments that are not interwoven with weft filaments are woven. As the additional warp filaments are not interwoven with weft filaments, the shortening is kept to a minimum.

The method according to the invention therefore allows to create a stiffener by creating a local allowance on the component, without impacting on the adjacent zones of the component. The stiffener according to the invention is more effective than the prior art stiffeners which can be obtained by a simple iso-weave, and therefore iso-shortening, allowance, i.e. without any gain in Young's modulus. The stiffener according to the invention allows to increase the circumferential stiffness of the turbomachine component, and therefore maximises the circumferential Young's modulus of the component.

The stiffener is formed directly into the component, thereby allowing to reduce the manufacturing costs. There is no need to make the stiffener separately and then integrate it into the component.

Preferably, the stiffening zone does not extend along the entire length of the component. In other words, the extent of the stiffening allowance is preferably minimal, in order to limit its effect on the mass of the component.

Advantageously, the zone of allowance is small in relation to the dimensions of the component, so as not to increase the thickness of the component over its entire surface. For example, the zone of allowance is less than 10% of the surface of the component. Limiting the extent of the allowance allows to return to a basic weave (i.e. a weave outside the stiffening zone), where all the warp filaments are interwoven with weft filaments, and therefore allows to confine the additional warp filaments not interwoven with weft filaments to their dedicated zone (i.e. the stiffening zone).

In one embodiment, the stiffening zone is formed by at least one layer of warp filaments not interwoven with weft filaments, the warp filaments of the layer of warp filaments not interwoven with weft filaments having a linear mass (i.e. a quantity of material per unit length) greater than that of the warp filaments and of weft filaments that are interwoven. For example, the linear mass of the warp filaments not interwoven with weft filaments is twice the linear mass of the warp filaments and weft filaments that are interwoven.

In another embodiment, the stiffening zone is formed by a plurality of layers of warp filaments not interwoven with weft filaments. These warp filaments not interwoven with weft filaments have a linear mass substantially equal to the linear mass of the warp filaments and weft filaments that are interwoven.

The number of additional warp filaments that are not interwoven with weft filaments depends on the final thickness of the component required. The number of these additional warp filaments is distinct from the number of the warp and weft filaments that are interwoven. The ratio between the number of additional warp filaments not interwoven with weft filaments and that of the warp and weft filaments that are interwoven can be between 0.25 and 4.

The fibrous preform may comprise N layers of warp filaments and M layers of weft filaments that are interwoven, where N and M are integers greater than or equal to three. The stiffening zone is located between a first skin formed by N1 layers of warp filaments and M1 layers of weft filaments that are interwoven, N1 and M1 being integers less than N and M respectively, and a second skin formed by the other N−N1 layers of warp filaments and the other M−M1 layers of weft filaments that are interwoven.

In other words, the warp filament or filaments not interwoven with weft filaments forming the stiffening zone are arranged in the middle of the thickness of the fibrous preform.

In one embodiment, the integers N and M are equal, for example each equal four, and the fibrous preform therefore comprises four layers of warp filaments and four layers of weft filaments that are interwoven. Preferably, the stiffening zone is located between a first skin formed by two layers of warp filaments and two layers of weft filaments that are interwoven, and a second skin formed by the other two layers of warp filaments and the other two layers of weft filaments that are interwoven.

In another embodiment, the integers N and M are equal, for example each equal eight, and the fibrous preform therefore comprises eight layers of warp filaments and eight layers of weft filaments that are interwoven. Preferably, the stiffening zone is located between a first skin formed by four layers of warp filaments and four layers of weft filaments that are interwoven, and a second skin formed by the other four layers of warp filaments and four layers of weft filaments that are interwoven.

The invention also relates to a turbomachine component obtained by the manufacturing method according to the invention, said component comprising a stiffening zone integrated into the fibrous preform, said stiffening zone being formed by at least one warp filament that is not interwoven with weft filaments interposed between the warp filaments and the weft filaments of the fibrous preform that are interwoven.

The stiffening zone forms an allowance to stiffen the component.

The warp filaments and the weft filaments can be fibres of a composite material, for example carbon, glass, aramid or ceramic.

In one embodiment, the stiffening zone is formed by a warp filament not interwoven with weft filaments having a linear mass greater than that of the warp filaments and of the weft filaments that are interwoven.

In another embodiment, the stiffening zone is formed by a plurality of warp filaments not interwoven with weft filaments. The warp filaments not interwoven with weft filaments have the same linear mass as the warp filaments and the weft filaments that are interwoven.

The resulting turbomachine component can be any axisymmetric or revolution component, produced by 3D filament weaving, and requiring a circumferential stiffening.

For example, the turbomachine component could be a fan casing or a ICS.

The resulting turbomachine component can also be an OGV.

### BRIEF DESCRIPTION OF FIGURES

The invention will be better understood and other details, characteristics and advantages of the present invention will become clearer from the following description made by way of non-limiting example and with reference to the attached drawings, in which:

FIG. 1A, already described, shows very schematically a turbomachine component with an integrated stiffener according to the prior art, while FIG. 1B shows very schematically a turbomachine component with an integrated stiffener according to the invention;

FIG. 2 shows a schematic representation of a weave of a turbomachine component produced by 3D filament weaving, without a stiffening zone;

FIG. 3 schematically represents a weave of a turbomachine component produced by 3D filament weaving, with a stiffening zone according to one embodiment of the invention; and

FIGS. 4A to 4H show schematically different planes of a weave of a turbomachine component produced by 3D weaving of filaments, with a stiffening zone according to one embodiment of the invention.

The elements having the same functions in the different embodiments have the same references in the figures.

### DESCRIPTION OF THE EMBODIMENTS

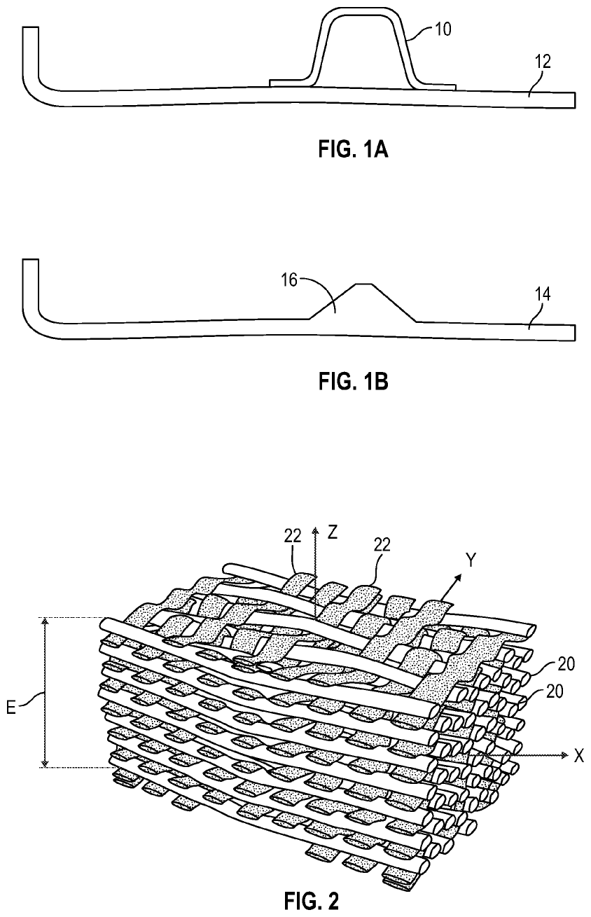

As shown in FIG. 1B, a turbomachine component 14 made of composite material comprises a stiffening zone 16.

The component may be tubular, for example a fan casing or a ICS. The turbomachine component can be any other axisymmetric component produced by 3D filament weaving, and requiring a circumferential stiffening. The component can also be an OGV.

The turbomachine component is made from a fibre-reinforced composite material preform densified by a matrix, for example a polymer.

The component is produced by a manufacturing method according to the invention as described below.

The method comprises a step in which a fibrous preform is produced by 3D filaments weaving so as to produce a fibrous texture, which is wound in several superposed layers on a mandrel with a profile corresponding to that of the component to be manufactured, in order to obtain the fibrous preform with a shape corresponding to that of the component to be manufactured. The filaments are separated into warp filaments and weft filaments, and the warp filaments are interwoven with the weft filaments in a 3D weaving.

The fibrous texture is woven onto a drum and then wound around a mandrel, the mandrel having a profile corresponding to that of the component to be produced, so as to obtain the desired fibrous preform. More precisely, the fibrous texture is in the form of a strip, produced by 3D weaving of warp filaments and weft filaments, which is wound over several turns around the mandrel to form the fibrous preform. The mandrel has an external surface whose profile corresponds to the internal surface of the component to be manufactured.

The 3D weaving is carried out by calling up the warp filaments onto the drum, the profile of which is chosen according to the component to be produced. In this way, the warp filaments can be called up by the drum, and the fibrous texture is wound onto the drum as it is woven.

The 3D weaving of the fibrous texture can be produced using an interlock weave with several layers of warp filaments and weft filaments. A 3D weaving with interlock weave is a weaving in which each warp filament connect several layers of weft filaments by interweaving. Of course, other weaving weaves are also possible.

By winding around the mandrel, the fibrous texture follows the profile of the latter. The number of layers of the fibrous texture wound to form the fibrous preform depends on the thickness of the desired component and the thickness of the fibrous texture. It is preferably greater than or equal to two.

When wound around a cylindrical mandrel, the fibrous preform can be tubular in shape so that a tubular component can be formed. The warp filaments of the fibrous texture are wound in the circumferential direction, allowing to give the component mechanical strength.

The fibrous preform is held on the mandrel and then impregnated with a resin, which is then polymerised. More specifically, counter-moulds are arranged around the fibrous preform held on the mandrel, and the fibrous preform is sealed in the counter-moulds. The whole set is then transported to an oven or a kiln where the preform is densified by a matrix. The densification of the fibrous preform consists in filling the porosity of the preform, in all or part of its volume, with the material making up the matrix. The matrix is obtained by injecting the resin into the fibrous preform and polymerising it by thermal treatment.

The fibrous preform can be densified using a transfer moulding (RTM, acronym for Resin Transfert Moulding) method. More specifically, the fibrous preform is placed in a mould having the shape of the component to be manufactured. A thermosetting resin is injected into the internal space defined between the mandrel and the mould, which comprises the fibrous preform. A pressure gradient is established in this internal space between the location where the resin is injected and the evacuation orifices of the latter, in order to control and optimise the impregnation of the fibrous preform by the resin.

The component is then removed from the mould and trimmed to remove the excess resin. The turbomachine component is thus obtained after finish machining.

FIG. 2 shows a weave, i.e. a mode of interweaving or interlacing the warp filaments and the weft filaments of the turbomachine component. The warp filaments 20 extend longitudinally along the axis X, while the weft filaments 22 extend longitudinally along the axis Y. The warp filaments 20 and the weft filaments 22 define layers of filaments, which are stacked along the axis Z, and which define the thickness E of the fibrous preform. In FIG. 2, there are eight layers of warp filaments 20 and eight layers of weft filaments 22. The warp filaments 20 are interwoven with the weft filaments 22 in a three-dimensional weaving. In FIG. 2, the interweaving mode of the warp filaments and weft filaments is shown outside a stiffening zone.

The method also comprises a step of creating a stiffening zone in the fibrous preform. The stiffening zone is formed by inserting at least one layer of warp filaments that not interwoven with weft filaments, and which is interposed between the warp filaments and the weft filaments that are interwoven. It is the fibrous preform comprising the stiffening zone or zones that is wound onto the mandrel, so as to form the turbomachine component, in a single piece, with stiffening zones.

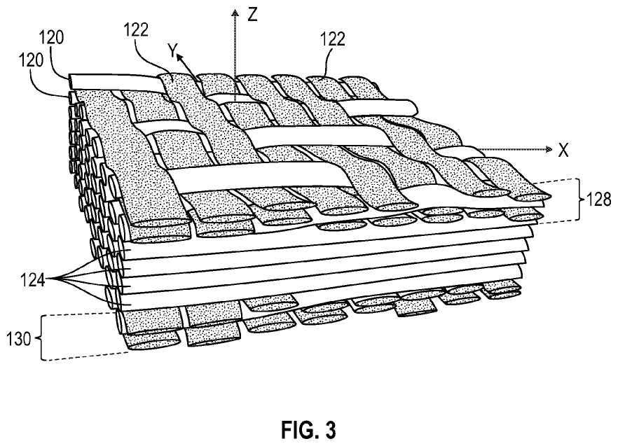

FIG. 3 shows the weave of the turbomachine component in the stiffening zone according to the invention. As before, the warp filaments 120 extend longitudinally along the axis X, the weft filaments 122 extend longitudinally along the axis Y, and the warp 120 and weft 122 filaments define layers of filaments, which are stacked along the axis Z, so as to define the thickness of the fibrous preform. The warp filaments 120 and the weft filaments 122 can be fibres of a composite material, for example carbon, so that the component obtained is made of carbon. In this figure, there are eight layers of warp filaments 120 and four layers of weft filaments 122. FIG. 3 shows how the warp filaments and the weft filaments are interwoven in the stiffening zone.

In the example shown in FIG. 3, the stiffening zone is formed by a plurality of layers of warp filaments that are not interwoven with weft filaments 124, four in number in the example shown. These warp filaments that are not interwoven with weft filaments 124 have the same linear mass as the warp filaments 120 and the weft filaments 122 that are interwoven. The number of warp filaments that are not interwoven with weft filaments 124, their nature and their dimensions depend on the turbomachine component required.

Generally speaking, the fibrous preform can comprise N layers of warp filaments 120 and M layers of weft filaments 122 that are interwoven, N and M being integers greater than or equal to three. The stiffening zone is located between a first skin formed by N1 layers of warp filaments and M1 layers of weft filaments that are interwoven, N1 and M1 being integers less than N and M respectively, and a second skin formed by the other layers of warp filaments (equal to N−N1) and the other layers of weft filaments (equal to M−M1) that are interwoven.

Preferably, the integers N and M are equal and preferably even so that the stiffening zone is integrated between two skins comprising the same number of layers of warp filaments and weft filaments that are interwoven.

In FIG. 3, N and M are equal to four. The stiffening zone is integrated between a first skin 128 formed by N/2 (here two) layers of warp filaments 120 and M/2 (here two) layers of weft filaments 122 that are interwoven, and a second skin 130 formed by the other N/2 layers of warp filaments 120 and the other M/2 layers of weft filaments 122 that are interwoven.

The number of layers of warp filaments and layers of weft filaments in each skin depends on the desired fibrous preform. In particular, in the case of a weave comprising four layers of warp filaments and four layers of weft filaments that are interwoven, the filament layers are separated into two skins each comprising two layers of warp filaments and two layers of weft filaments that are interwoven, but in the case of a weave comprising eight layers of warp filaments and eight layers of weft filaments that are interwoven, the filament layers are separated into two skins each comprising four layers of warp filaments and four layers of weft filaments that are interwoven. In this way, the layer or layers of warp filaments that are not interwoven with weft filaments 124 are arranged in the middle of the thickness of the fibrous preform. More precisely, the four layers of warp filaments 120 and four layers of weft filaments 122 that are interwoven separate into two skins each formed by two layers of warp filaments 120 and two layers of weft filaments 122 that are interwoven, which allows to insert between these two skins 128, 130, one or more additional layers of warp filaments not requiring weft filaments.

As the warp filament or filaments 124 are not interwoven with weft filaments, they are free of shortening, and are therefore comparable to unidirectional filaments in the case of components made of composite material woven in two-dimensions (2D).

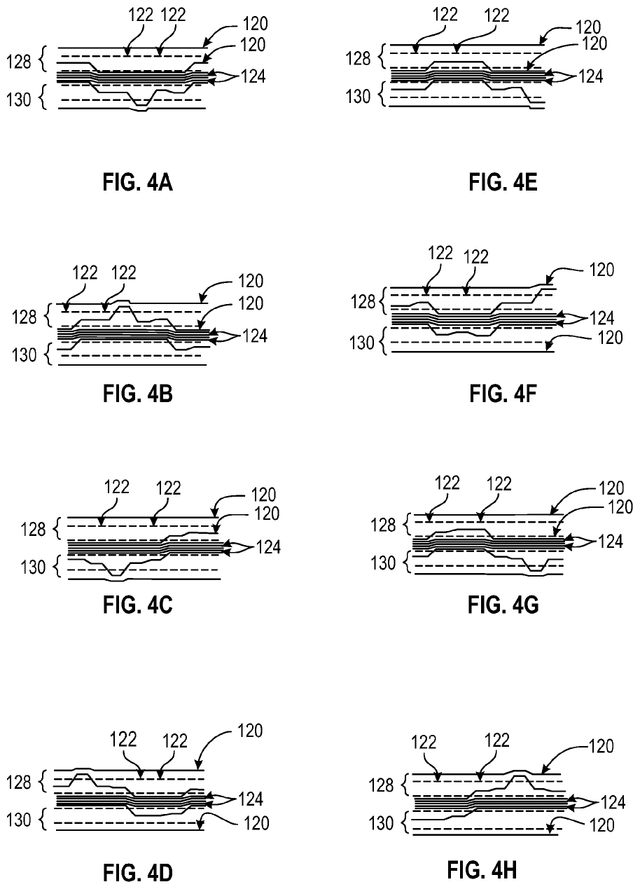

FIGS. 4A to 4H show different planes of the weave in FIG. 3. These figures show how the warp filaments 120 are interwoven with the weft filaments 122. Additional warp filaments that are not interwoven with weft filaments 124 are inserted into the core of the layers of warp filaments 120 and weft filaments 122 that are interwoven. More precisely, the layers of warp filaments 120 and weft filaments 122 are separated into two skins 128, 130, each comprising two layers of warp filaments 120 and two layers of weft filaments 122 that are interwoven, and between these skins 128, 130, the layers of warp filaments non-interwoven with weft filaments 124 are inserted. In the example shown, four layers of warp filaments not interwoven with weft filaments are inserted between the two skins 128, 130. The allowance that forms the stiffening zone is thus formed by these warp filaments that are not interwoven with weft filaments 124.

In order to maximise the circumferential Young's modulus in the direction of the warp filaments, the 3D weaving of the fibrous preform is carried out with the weave shown in FIG. 3 in the stiffening zone, and with a basic weave (a weave like that shown in FIG. 2, but with only four layers of warp filaments and four layers of weft filaments that are interwoven instead of the eight layers of filaments shown in FIG. 2) for the zones of the component outside the stiffening zone. In this way, the component keep the same outer appearance of the weaving in and out of the stiffening zone, while minimising any shortening of the warp filament or filaments that are not interwoven with weft filaments 124 in the stiffening zone.

Compared with a 3D woven fibrous preform with basic weave (with eight layers of warp filaments and eight layers of weft filaments that are interwoven, the filaments having a number of strands per section of 48 k), the circumferential Young's modulus of a 3D woven fibrous preform with a weave according to FIG. 3 (with two skins of two layers of warp filaments and of weft filaments that are interwoven, the filaments having a number of strands per section of 48 k, and with two additional layers of warp filaments that are not interwoven with weft filaments of 48 k), shows a gain of at least 40%.

1. A method for manufacturing a turbomachine component made of composite material, said method comprising the steps of:
producing a fibrous preform by three-dimensional weaving of filaments so as to produce a fibrous texture, which is wound in a plurality of superposed layers on a mandrel with a profile corresponding to that of the component to be manufactured, in order to obtain the fibrous preform with a shape corresponding to that of the component to be manufactured, the filaments being separated into warp filaments and weft filaments, the warp filaments being interwoven with the weft filaments in a three-dimensional weaving, and
creating a stiffening zone in the fibrous preform,
wherein said stiffening zone is formed by at least one layer of warp filaments not interwoven with weft filaments interposed between the warp filaments and the weft filaments that are interwoven.

2. The method according to claim 1, wherein the stiffening zone is formed by a layer of warp filaments that are not interwoven with weft filaments, the warp filaments of the layer of warp filaments not interwoven with weft filaments having a linear mass greater than that of the warp filaments and the weft filaments that are interwoven.

3. The method according to claim 1, wherein the stiffening zone is formed by a plurality of layers of warp filaments that are not interwoven with weft filaments.

4. The method according to claim 1, wherein the fibrous preform comprises N layers of warp filaments and M layers of weft filaments that are interwoven, N and M being integers greater than or equal to three, the stiffening zone being located between a first skin formed by N1 layers of warp filaments and M1 layers of weft filaments that are interwoven, N1 and M1 being integers respectively less than N and M, and a second skin formed by the other N−N1 layers of warp filaments and the other M−M1 layers of weft filaments that are interwoven.

5. A turbomachine component obtained by the manufacturing method according to claim 1, said component comprising a stiffening zone integrated into the fibrous preform, said stiffening zone being formed by at least one layer of warp filaments non-interwoven with weft filaments interposed between the warp filaments and the weft filaments of the fibrous preform that are interwoven.

6. The turbomachine component according to claim 5, wherein the stiffening zone forms an allowance for stiffening the component.

7. The turbomachine component according to claim 5, wherein the warp filaments and the weft filaments are fibres fibers of composite material.

8. The turbomachine component according to claim 5, wherein the stiffening zone is formed by a layer of warp filaments non-interwoven with weft filaments having a linear mass greater than that of the warp filaments and of the weft filaments that are interwoven.

9. The turbomachine component according to claim 5, wherein the stiffening zone is formed by a plurality of layers of warp filaments not-interwoven with weft filaments.

10. The turbomachine component according to claim 5, wherein the component is a casing, or an intermediate casing shell, or an outlet flow guide vane.
